(19) United States
(12) Patent Application Publication
(10) Pub. No.: US 2013/0119696 A1
(43) Pub. Date: May 16, 2013

(54) ENCAPSULATED WINDSHIELD MOLDING AND METHOD FOR ATTACHING A WINDSHIELD

(71) Applicant: Raymond William Baggett, Skiatook, OK (US)

(72) Inventor: Raymond William Baggett, Skiatook, OK (US)

(73) Assignee: International Truck Intellectual Property Company,, Lisle, IL (US)

(21) Appl. No.: 13/810,223

(22) PCT Filed: Jul. 22, 2010
(86) PCT No.: PCT/US10/42919

§ 371 Date: Jan. 15, 2013

(51) Int. Cl. B60J 1/00

(52) U.S. Cl. CPC B60J 1/006
USPC 296/96.21; 156/108

(57) ABSTRACT

An encapsulated windshield molding for attaching a windshield to a vehicle structure includes a body that at least partially encapsulates the windshield. A windshield receiving portion is defined by the body and is configured to receive the windshield. A carrier that is formed of a different material than the body is attached to the body and is configured to be adhered to the vehicle structure.

### BACKGROUND

Embodiments described herein relate to a windshield molding and a method for installing a windshield onto a vehicle structure.

One of the ways that windshields are conventionally mounted onto a vehicle is with a roped-in gasket-seal mounting. In the roped-in mounting, the windshield is installed using a rope to pry a rubber gasket over the peripheral edge of the windshield glass.

Another conventional method of mounting a windshield is the bonded-in mounting, where the glass is directly bonded to the vehicle structure. The bonded-in mounting provides a glass surface and vehicle structure surface that are nearly in the same plane. In the bonded-in mounting, an adhesive is used to bond the glass directly to the vehicle structure. Often a polymer trim is applied to the edge of the glass either as a separate part or as an injected encapsulation to reduce drag at the junction of the windshield to the vehicle structure.

Since the windshield is directly bonded to the vehicle structure, bonded-in windshields are harder to replace in service than roped-in windshields, but bonded-in windshields are more easily installed at initial installation and are also less likely to leak than roped-in windshields. Roped-in windshields are more easily replaced in field service than bonded-in windshields, but roped-in windshields are harder to initially install and are also more likely to leak than bonded-in windshields.

### SUMMARY

An encapsulated windshield molding for attaching a windshield to a vehicle structure includes a body that at least partially encapsulates the windshield. A windshield receiving portion is defined by the body and is configured to receive the windshield. A carrier that is formed of a different material than the body is attached to the body and is configured to be adhered to the vehicle structure.

In another embodiment, an encapsulated windshield molding for attaching a windshield to a vehicle structure includes a flexible body that at least partially encapsulates the windshield. The body has a front surface and a rear surface. A carrier is attached to the rear surface of the body and is configured to be adhered to the vehicle structure. A flexure formation is defined by the front surface of the body, and an insert having a complementary shape to the flexure formation is configured to be selectively received into the flexure formation. A windshield receiving portion is defined by the body and is configured to receive the windshield, and a flexure portion of the body is disposed between the windshield receiving portion and the flexure formation.

A method of attaching a windshield to a vehicle structure includes the steps of providing a body defining a windshield receiving portion and configured to receive a carrier formed of a different material than the body. The method also includes adhering the carrier to the vehicle structure with a windshield adhesive, and inserting the windshield into the receiving portion.

### BRIEF DESCRIPTION OF THE DRAWINGS

FIG. 1 is a section view of an encapsulated windshield molding attaching a windshield to a vehicle structure.

### DETAILED DESCRIPTION

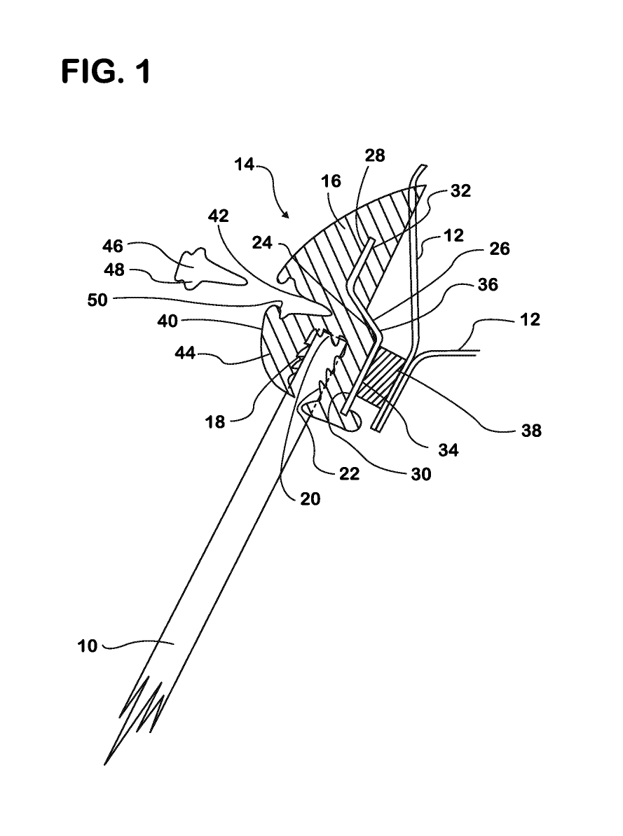

Referring to FIG. 1, an encapsulated windshield molding for attaching a windshield 10 to a vehicle structure 12 is indicated generally at 14. Although the following description will be directed to the encapsulated windshield molding 14 at the location of the top of the windshield 12 and the top opening of the vehicle structure 12, the molding 14 of FIG. 1 may extend around the entire periphery of the windshield. It is possible that the cross-sectional shape of the molding 14 may vary according to where it is located on the periphery of the windshield 10, and the shape of the vehicle structure 12.

The encapsulated windshield molding 14 includes a body 16 that may be formed of rubber or an injection molded plastic, although other resilient or elastomeric materials and methods of forming the body are possible. It is possible that the body 16 can have various coextruded shapes, or can be formed of one or more materials or types of materials.

The body 16 defines a windshield receiving portion 18, such as a generally rectangular-shaped channel, that is configured to receive and at least partially encapsulate a peripheral edge 20 of the windshield 10. A plurality of protrusions 22 may be disposed in the windshield receiving portion 18 to seal the windshield 10 to the body 16 when the windshield is disposed in the windshield receiving portion.

The body 16 also includes a carrier receiving portion 24 that is configured to receive a carrier 26. The carrier 26 is formed of a different material than the body 16, and may be formed of metals such as steel, however any sort of hard material that will adhere well to the body, such as polymeric materials, may be used.

The carrier receiving portion 24 may include a carrier channel 28 disposed into the interior of the body 16, and a rear surface 30 of the body. A first portion 32 of the carrier 26 may be received into the carrier channel 28 of the body 16 and bonded into place, and a second portion 34 of the carrier may be disposed adjacent to and bonded to the rear surface 30 of the body, however the carrier may be attached to the body in other ways. Alternatively, the carrier 28 may be disposed along the rear surface 30 of the body 16 without being disposed in an interior channel of the body.

The first portion 32 and the second portion 34 of the carrier 26 may be generally parallel and offset with a third portion 36 that may be at least partially embedded in the body 16 with the first portion 32. The second portion 34 may be generally parallel with the windshield receiving portion 18, however other orientations are possible. The carrier 26 may have any shape and configuration that allows the adhesion of the carrier 26 to the body 16.

A windshield adhesive 38 adheres the carrier 26 and the body 16 to the vehicle structure 12. Since windshield adhesives 38 typically adhere well to metal and hard materials, but do not typically adhere well to other materials such as rubber, the carrier 26 attaches the body 16 to the vehicle structure 12. Additionally, it is possible that the body 16 may engage with the vehicle structure 12, such as with a hook or clip, to provide additional attachment of the body to the vehicle structure.

A front surface 40 of the body 16 may be generally curved to reduce drag at the junction of the windshield 10 to the vehicle structure 12. The front surface 40 of the body 16 includes a flexure formation 42, such as a female or wedge-shaped channel defined by the body, however other formations are possible. The flexure formation 42 may be generally perpendicular to the windshield receiving portion 18, however other orientations are possible. A flexure portion 44 of the body 16 may be disposed between the windshield receiving portion 18 and the flexure formation 42.

An insert 46 having a generally complementary shape to the flexure formation 42, such as a male or wedge-shaped plug, is configured to be selectively and matingly received in the flexure formation. The insert 46 may be made of a harder durometer rubber than the body 16, or any other hard material. A locking formation 48, such as two ears, may be disposed on the insert 46 and be configured to be received by a corresponding locking formation 50 on the flexure formation 42. When the insert 46 is removed from the flexure formation 42, the flexure portion 44 is displaceable towards the flexure formation 42.

When the windshield 10 is installed in the body 16, the insert 46 may be removed from the body. With the insert 46 removed from the body 16, the body may deform at the flexure portion 44 to allow the edge 20 of the windshield 10 to be more easily inserted into the windshield receiving portion 18. After insertion of the windshield 10 into the windshield receiving portion 18, the insert 46 may be inserted into the flexure formation 42, which imparts a clamping force on the body 16 at the flexure portion 44 to secure the windshield in the windshield receiving portion. Further, the insert 46 may be locked into the flexure formation 42 with the engagement of the locking formations 48, 50.

The encapsulated windshield molding 14 is a hybrid of the roped-in mounting method and the bonded-in mounting method in that the body 16 forms a seal around the windshield 10 similar to a roped-in windshield, and the carrier 26 allows the windshield 10 to be adhered to the vehicle structure 12. The adhesive 38 can be applied to the carrier 26 rather than directly to the windshield 10. Together, the body 16 of the encapsulated windshield molding 14 and the carrier 26 sealingly attach the windshield 10 to the vehicle structure 12. With the encapsulated windshield molding 14, the windshield 10 may be both installed and removed from the body 16 at initial installation and during in-service repairs by removing the insert 46 from the body, and inserting or removing the windshield 10 with respect to the windshield receiving portion 18.

What is claimed is:

1. An encapsulated windshield molding for attaching a windshield to a vehicle structure includes:
a body that at least partially encapsulates the windshield;
a windshield receiving portion defined by the body and configured to receive the windshield; and
a carrier formed of a different material than the body, wherein the carrier is attached to the body and is configured to be adhered to the vehicle structure.

2. The encapsulated windshield molding of claim 1 further comprising:
a flexure formation defined by the body;
a flexure portion of the body disposed between the windshield receiving portion and the flexure formation; and
an insert having a generally complementary shape to the flexure formation and configured to be selectively received by the flexure formation.

3. The encapsulated windshield molding of claim 2 wherein the flexure formation is disposed on a front surface of the body, and the carrier is disposed on a rear surface of the body.

4. The encapsulated windshield molding of claim 2 wherein the flexure formation is generally wedge-shaped.

5. The encapsulated windshield molding of claim 2 wherein the insert is formed of a harder durometer material than the body.

6. The encapsulated windshield molding of claim 2 wherein the flexure portion of the body is displaceable towards the flexure formation when the insert is removed from the flexure formation.

7. The encapsulated windshield molding of claim 1 wherein the windshield receiving portion and the flexure formation are generally perpendicular to each other.

8. The encapsulated windshield molding of claim 1 wherein the body is formed of one of rubber and plastic.

9. The encapsulated windshield molding of claim 1 wherein the carrier is formed of metal.

10. The encapsulated windshield molding of claim 1 wherein the body comprises a carrier channel configured to receive a first portion of the carrier.

11. The encapsulated windshield molding of claim 10 wherein the carrier comprises a second portion that is bonded to a rear surface of the body, wherein the first portion and the second portion are generally parallel.

12. A method of attaching a windshield to a vehicle structure, the method comprising the steps of:
providing an encapsulated molding having a body, the body defining a windshield receiving portion and the body configured to receive a carrier formed of a different material than the body;
adhering the carrier to the vehicle structure with a windshield adhesive; and
inserting the windshield into the receiving portion of the body.

13. The method of claim 12 further comprising the step of flexing a flexure portion of the body towards a flexure formation defined by the body when the windshield is inserted into the receiving portion, wherein the flexure portion is disposed between the windshield receiving portion and the flexure formation.

14. The method of claim 12 further comprising the step of inserting an insert into the flexure formation after the windshield is inserted into the receiving portion.

15. The method of claim 12 further comprising the step of removing the insert from the flexure formation before inserting the windshield into the receiving portion.

16. The method of claim 12 further comprising the step of attaching the carrier to the body before adhering the carrier to the vehicle structure.

17. The method of claim 12 further comprising the step of sealing the windshield to the body with a plurality of protrusions.

18. An encapsulated windshield molding for attaching a windshield to a vehicle structure includes:
a flexible body that at least partially encapsulates the windshield, the body having a front surface and a rear surface;
a carrier attached to the rear surface of the body and configured to be adhered to the vehicle structure;
a flexure formation defined by the front surface of the body;
an insert having a complementary shape to the flexure formation, the insert configured to be selectively received into the flexure formation;
a windshield receiving portion defined by the body and configured to receive the windshield; and
a flexure portion of the body disposed between the windshield receiving portion and the flexure formation.

19. The encapsulated windshield molding of claim 18 wherein the flexure formation is female-shaped, and the insert is male-shaped.

20. The encapsulated windshield molding of claim 18 wherein the flexure portion of the body is configured to flex towards the flexure formation when the insert is removed from the flexure formation.
